(19) United States
(12) Patent Application Publication
(10) Pub. No.: US 2021/0189686 A1
(43) Pub. Date: Jun. 24, 2021

(54) ELECTRIC MOTOR, ROTARY DRIVE SYSTEM, AND HYDRAULIC SHOVEL

(71) Applicant: Komatsu Ltd., Tokyo (JP)

(72) Inventors: Akira Minamiura, Tokyo (JP); Teiichirou Chiba, Tokyo (JP)

(21) Appl. No.: 16/757,464

(22) PCT Filed: Jan. 17, 2019
(86) PCT No.: PCT/JP2019/001251

§ 371 Date: Apr. 20, 2020

(30) Foreign Application Priority Data
Feb. 28, 2018 (JP) 2018-035842

(51) Int. Cl. E02F 9/12; F16H 57/04; H02K 7/08; H02K 7/102; H02K 7/116; H02K 9/19

(52) U.S. Cl. CPC E02F 9/126; F16H 57/0445; E02F 9/123; E02F 9/125; E02F 9/128; F16H 57/0424; F16H 2057/02034; F16H 57/0471; F16H 57/0476; H02K 7/083; H02K 7/102; H02K 7/116; H02K 9/19; F16H 57/045

(57) ABSTRACT

An electric motor includes a rotor having a rotary shaft rotating around a vertically extending axis and a rotor core fixed to an outer peripheral surface of the rotary shaft, a stator surrounding the rotor core from an outer peripheral side, a lower bottom portion as a partition wall partitioning a first space where the rotor and the stator are disposed and a lubricating oil is supplied from an outside, a storage portion configured to store the lubricating oil supplied into the first space, a brake mechanism as a drive unit discharging the lubricating oil inside the storage portion into the first space, and sliding portions into each of which the lubricating oil discharged from the inside of the storage portion is introduced.

### TECHNICAL FIELD

The present invention relates to an electric motor, a rotary drive system, and a hydraulic shovel.

Priority is claimed on Japanese Patent Application No. 2018-035842, filed on Feb. 28, 2018, the content of which is incorporated herein by reference.

### BACKGROUND ART

PTL 1 discloses a hydraulic shovel provided with a rotary drive system swinging an upper swing body with respect to an undercarriage. The rotary drive system includes an electric motor and a speed reducer decelerating the rotation of the electric motor. The rotary drive system is provided with a brake for preventing inadvertent rotation in a stopped state. The brake includes a brake disk capable of rotating integrally with a rotary shaft and a brake piston pressing the brake disk.

Lubricating oil is supplied from the outside to the electric motor of the rotary drive system so that cooling capability is ensured for a rotor and a stator and lubricity is ensured for each sliding portion such as a bearing. The lubricating oil is supplied into the electric motor by a lubricating oil pump being driven.

### CITATION LIST

### Patent Literature

[PTL 1] Japanese Unexamined Patent Application, First Publication No. 2016-172965

### DISCLOSURE OF INVENTION

### Technical Problem

By the way, when the electric motor that is in a stopped state is started and the rotor rotates, lubricating oil is supplied into the electric motor by the lubricating oil pump being driven at the same time. However, there is a time difference between the driving of the lubricating oil pump and the lubricating oil reaching the sliding portion. In addition, viscosity of the lubricating oil is high at a low temperature in particular, and thus it takes time for the lubricating oil to reach the sliding portion.

The present invention has been made in view of such problems, and an object of the present invention is to provide an electric motor, a rotary drive system, and a hydraulic shovel allowing lubricating oil to be smoothly supplied to a sliding portion.

### Solution to Problem

An electric motor according to an aspect of the present invention includes: a rotor including a rotary shaft that has an axis extending vertically and rotates around the axis and a rotor core fixed to an outer peripheral surface of the rotary shaft; a stator surrounding the rotor core from an outer peripheral side of the stator; a partition wall partitioning a first space where the rotor and the stator are disposed and lubricating oil is supplied from an outside; a storage portion configured to store the lubricating oil supplied into the first space; a drive unit discharging the lubricating oil inside the storage portion into the first space; and sliding portions into each of which the lubricating oil discharged from the inside of the storage portion is introduced.

According to the electric motor configured as described above, lubricity is ensured in the sliding portion by the lubricating oil supplied to the first space from the outside. In addition, the lubricating oil is introduced into the storage portion. As a result, lubricating oil is stored in the storage portion.

Additionally, in a case where it is difficult to supply lubricating oil from the outside to the first space, for example, the lubricating oil stored in the storage portion is discharged into the first space by the drive unit. The lubricating oil discharged in this manner lubricates the sliding portion by being introduced into the sliding portion.

Accordingly, it is possible to smoothly supply the lubricating oil discharged from the storage portion to the sliding portion even in a situation in which it is difficult to supply lubricating oil from the outside.

### Advantageous Effects of Invention

According to the electric motor, the rotary drive system, and the hydraulic shovel of the above aspect, it is possible to smoothly supply lubricating oil to a sliding portion.

### BRIEF DESCRIPTION OF DRAWINGS

FIG. 1 is a side view of a hydraulic shovel including a rotary drive system according to a first embodiment of the present invention.

FIG. 2 is a plan view of the hydraulic shovel including the rotary drive system according to the first embodiment of the present invention.

FIG. 3 is a schematic diagram showing an outline of the rotary drive system according to the first embodiment of the present invention.

FIG. 4 is a longitudinal cross-sectional view of a rotary drive device in the rotary drive system according to the first embodiment of the present invention.

FIG. 5 is an enlarged view of the vicinity of a brake mechanism in FIG. 4 and is a diagram showing a state where a brake piston is at a bottom dead center.

FIG. 6 is an enlarged view of the vicinity of the brake mechanism in FIG. 4 and is a diagram showing a state where the brake piston is at a top dead center.

FIG. 7 is an enlarged view of a main portion of an electric motor of a rotary drive system according to a second embodiment of the present invention.

### BEST MODE FOR CARRYING OUT THE INVENTION

### First Embodiment

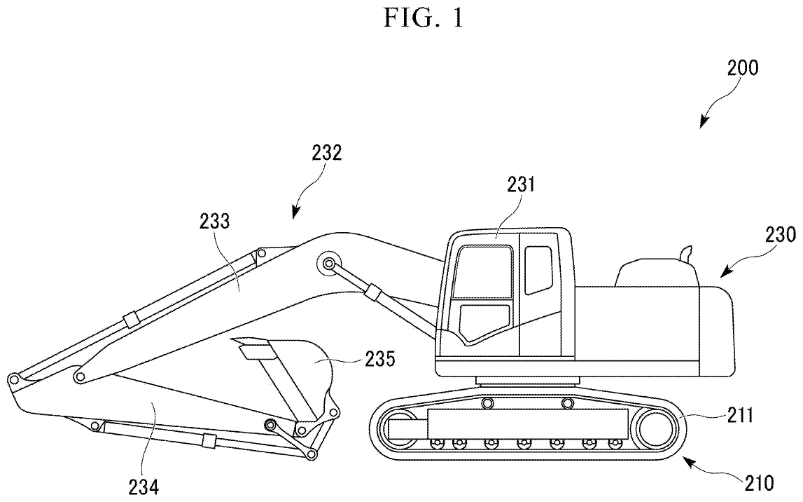

Hereinafter, a first embodiment of the present invention will be described in detail with reference to FIGS. 1 to 6.

<Work Machine>

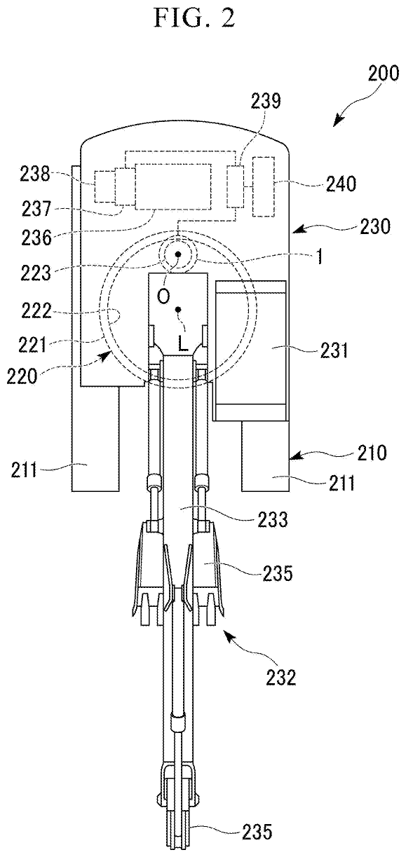

As shown in FIGS. 1 and 2, a hydraulic shovel 200 as a work machine includes an undercarriage 210, a swing circle 220, and an upper swing body 230. In the following description, the direction in which gravity acts in a state where the work machine is installed on a horizontal surface will be referred to as “vertical direction”. In addition, the front of the driver's seat in a cab 231 (described later) will be simply referred to as “front” and the rear of the driver's seat will be simply referred to as “rear”.

The undercarriage 210 includes a pair of left and right crawlers 211 and 211 and the hydraulic shovel 200 travels by the crawlers 211 and 211 being driven by a traveling hydraulic motor (not shown).

The swing circle 220 is a member interconnecting the undercarriage 210 and the upper swing body 230 and includes an outer race 221, an inner race 222, and a swing pinion 223. The outer race 221 is supported by the undercarriage 210 and has an annular shape about a swing axis L extending so as to match the vertical direction. The inner race 222 is an annular member coaxial with the outer race 221 and is disposed inside the outer race 221. The inner race 222 is supported so as to be rotatable relative to the outer race 221 around the swing axis L. The swing pinion 223 meshes with internal teeth of the inner race 222 and the inner race 222 rotates relative to the outer race 221 by the swing pinion 223 rotating.

The upper swing body 230 is disposed so as to be capable of swinging around the swing axis L with respect to the undercarriage 210 by being supported by the inner race 222. The upper swing body 230 includes the cab 231, a work equipment 232, an engine 236 provided behind the cab 231 and the work equipment 232, a generator motor 237, a hydraulic pump 238, an inverter 239, a capacitor 240, and a rotary drive system 1.

The cab 231 is disposed on the front left side of the upper swing body 230 and is provided with the driver's seat for a worker. The work equipment 232 is provided so as to extend in front of the upper swing body 230 and includes a boom 233, an arm 234, and a bucket 235. The work equipment 232 performs various works such as excavation by the boom 233, the arm 234, and the bucket 235 being respectively driven by hydraulic cylinders (not shown).

The shafts of the engine 236 and the generator motor 237 are spline-coupled. The generator motor 237 generates electric power by being driven by the engine 236. The rotary shafts of the generator motor 237 and the hydraulic pump 238 are spline-coupled. The hydraulic pump 238 is driven by the engine 236. Each of the hydraulic cylinders and the traveling hydraulic motor described above are driven by the hydraulic pressure that is generated by the hydraulic pump 238 being driven.

The generator motor 237, the capacitor 240, and the rotary drive system 1 are electrically interconnected via the inverter 239. In addition, another electric power storage device such as a lithium-ion battery may be used instead of the capacitor 240.

The rotary drive system 1 is disposed in a vertically disposed state where an axis O as a rotation center matches the vertical direction. The output of the rotary drive system 1 is transmitted to the swing pinion 223 meshing with the internal teeth of the inner race 222.

The hydraulic shovel 200 drives the rotary drive system 1 with the electric power generated by the generator motor 237 or the electric power from the capacitor 240. The drive force of the rotary drive system 1 is transmitted to the inner race 222 via the swing pinion 223. As a result, the upper swing body 230 swings by the inner race 222 rotating relative to the outer race 221.

When the swinging of the upper swing body 230 is decelerated, the rotary drive system 1 generates electric power as regenerative energy by functioning as a generator. This electric power is accumulated in the capacitor 240 via the inverter 239. The electric power accumulated in the capacitor 240 is supplied to the generator motor 237 when the engine 236 is accelerated. The generator motor 237 assists the output of the engine 236 by the generator motor 237 being driven by the electric power of the capacitor.

<Rotary Drive System>

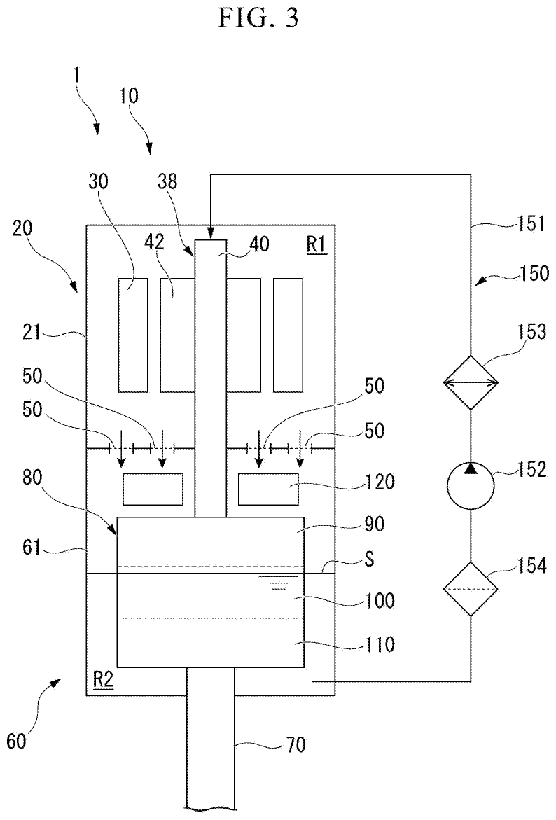

As shown in FIG. 3, the rotary drive system 1 includes a rotary drive device 10 and a lubricating oil circulation unit 150. A speed reducer 60 is installed below an electric motor 20.

<Rotary Drive Device>

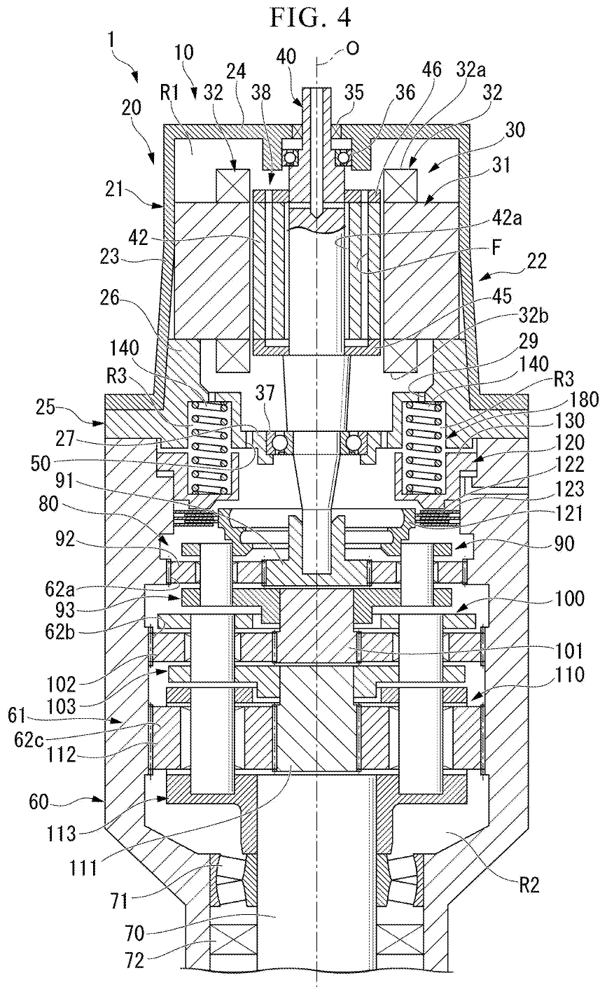

As shown in FIGS. 3 and 4, the rotary drive device 10 includes the electric motor 20 and the speed reducer 60 provided integrally with the electric motor 20.

<Electric Motor>

As shown in FIGS. 3 and 4, the electric motor 20 includes an electric motor casing 21, a stator 30, and a rotor 38.

Further, the electric motor 20 includes a brake mechanism 120. In the present embodiment, the brake mechanism 120 is accommodated in the speed reducer 60. Accordingly, details of the brake mechanism 120 will be described in the description of the speed reducer 60.

<Electric Motor Casing>

As shown in FIG. 4, the electric motor casing 21 is a member forming the outer shape of the electric motor 20. The electric motor casing 21 includes an upper casing 22 and a lower casing 25.

The upper casing 22 has a bottomed cylindrical shape having an upper cylindrical portion 23 that has a cylindrical shape and extends in the vertical direction (axis O direction) and an upper bottom portion 24 blocking the upper part of the upper cylindrical portion 23.

The lower casing 25 has a bottomed cylindrical shape having a lower cylindrical portion 26 that has a cylindrical shape and extends in the vertical direction and a lower bottom portion 27 blocking the lower part of the lower cylindrical portion 26. The lower bottom portion 27 is an example of the partition wall that vertically divides a first space R1 and a second space R2 (described later).

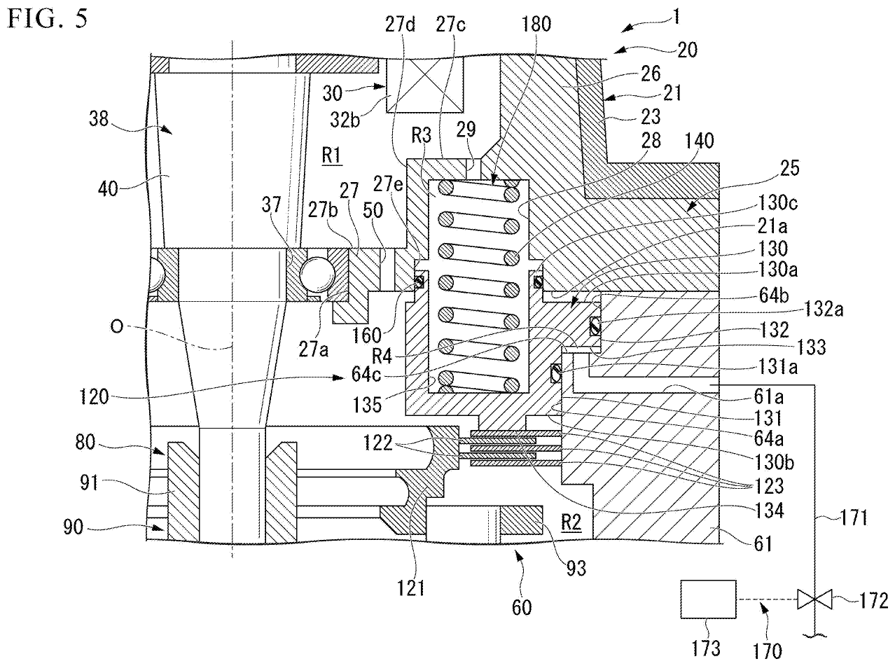

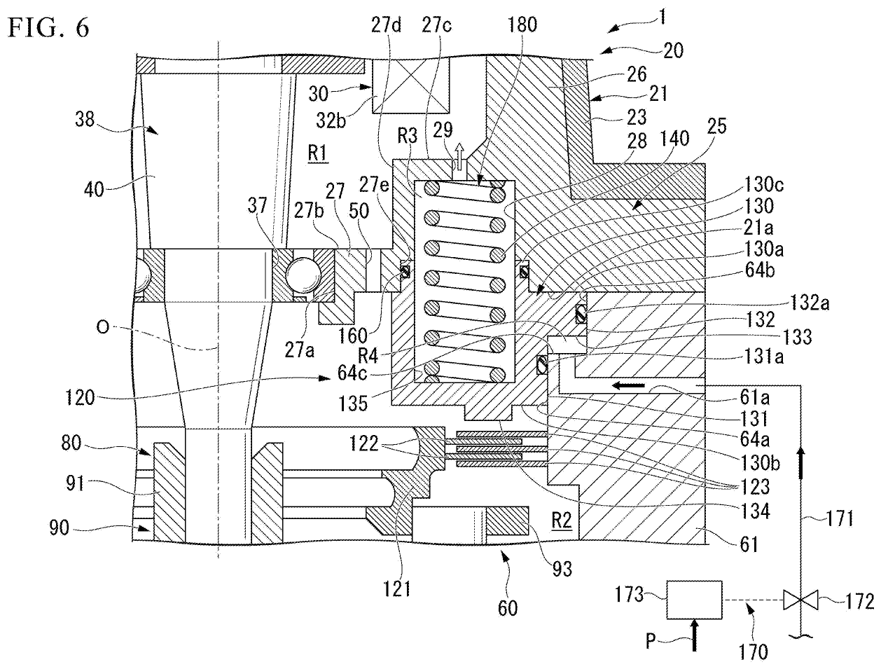

The lower bottom portion 27 serves as the bottom portion of the electric motor casing 21. Specifically, as shown in FIGS. 5 and 6, the lower bottom portion 27 has a lower through hole 27a penetrating the lower bottom portion 27 about the axis O. The part that is around the lower through hole 27a on the surface of the lower bottom portion 27 facing upward is an annular first bottom surface 27b having a flat shape orthogonal to the axis O. A second bottom surface 27c formed one step higher than the first bottom surface 27b is formed on the outer peripheral side of the first bottom surface 27b of the lower bottom portion 27. A plurality of the second bottom surfaces 27c may be divided in the circumferential direction. The first bottom surface 27b and the second bottom surface 27c are interconnected by a stepped portion 27d extending in the vertical direction. The outer peripheral side end portion of the second bottom surface 27c is connected to the inner peripheral surface of the lower cylindrical portion 26.

The outer peripheral surface of the lower cylindrical portion 26 is fitted to the inner peripheral surface of the upper cylindrical portion 23 in such a manner that the lower cylindrical portion 26 is inserted into the upper cylindrical portion 23 from below. As a result, the lower cylindrical portion 26 and the upper cylindrical portion 23 are integrally fixed to each other. The space inside the electric motor casing 21 that is formed by the lower cylindrical portion 26 and the upper cylindrical portion 23 is the first space R1.

<Communication Hole>

Here, as shown in FIGS. 5 and 6, the electric motor casing 21 has a communication hole 50 allowing the first space R1 in the electric motor casing 21 to communicate downward.

In the present embodiment, the communication hole 50 is formed so as to open to the first bottom surface 27b in the lower bottom portion 27 of the lower casing 25 and vertically penetrates the lower bottom portion 27. A plurality of the communication holes 50 arc formed at intervals in the circumferential direction.

In addition, another communication hole may be formed at, for example, another part of the lower bottom portion 27. Further, another communication hole vertically penetrating the lower cylindrical portion 26 may be formed.

<Stator>

As shown in FIG. 4, the stator 30 includes a stator core 31 and a coil 32.

The stator core 31 is configured by a plurality of electromagnetic steel plates being stacked in the vertical direction and has a cylindrical shape about the axis O. The stator core 31 includes a yoke and a plurality of teeth formed at intervals in the circumferential direction of the yoke so as to protrude from the inner peripheral surface of the yoke. The stator core is fixed to the electric motor casing 21.

A plurality of the coils 32 are provided so as to correspond to the respective teeth and wound around the respective teeth. As a result, the plurality of coils 32 are provided at intervals in the circumferential direction. The part of each coil 32 that protrudes upward from the stator core 31 is an upper coil end 32a. The part of each coil 32 that protrudes downward from the stator core 31 is a lower coil end 32b.

<Rotor>

As shown in FIG. 4, the rotor 38 includes a rotary shaft 40, a rotor core 42, a lower end plate 45, and an upper end plate 46.

<Rotary Shaft>

The rotary shaft 40 is a rod-shaped member extending along the axis O. The rotary shaft 40 is disposed in the electric motor casing 21 so as to penetrate the inside of the stator 30 in the vertical direction. The upper end of the rotary shaft 40 protrudes above the upper bottom portion 24 in the upper casing 22. In addition, the upper end of the rotary shaft 40 may be accommodated in the electric motor casing 21.

The upper bottom portion 24 is provided with an upper seal 35 for sealing between the upper bottom portion 24 and the outer peripheral surface of the rotary shaft 40. As a result, liquid tightness is ensured at the upper end inside the electric motor casing 21.

<Rotor Core>

The rotor core 42 has a cylindrical shape about the axis O and an inner peripheral surface 42a is externally fitted on the outer peripheral surface of the rotary shaft 40. The rotor core 42 is configured by a plurality of electromagnetic steel plates being stacked in the vertical direction. In the rotor core 42, a plurality of permanent magnets (not shown) are embedded at intervals in the circumferential direction.

<Lower End Plate>

The lower end plate 45 is fixed so as to be stacked on the rotor core 42 from below the rotor core 42.

<Upper End Plate>

The upper end plate 46 is fixed so as to be stacked on the rotor core 42 from above the rotor core 42.

<Intra-rotor Flow Path F>

The rotor 38 has an intra-rotor flow path F extending downward from the upper end of the rotary shaft 40 and passing between the rotary shaft 40 and the rotor core 42, through the lower end plate 45, through the rotor core 42, and through the upper end plate 46. The intra-rotor flow path F is open from the upper surface of the upper end plate 46 into the first space R1.

<Upper Bearing>

The upper bottom portion 24 is provided with an upper bearing 36 having an annular shape about the axis O. The rotary shaft 40 is vertically inserted through the upper bearing 36 and the upper portion of the rotary shaft 40 is supported by the upper bearing 36 so as to be rotatable around the axis O.

<Lower Bearing (Sliding Portion)>

As shown in FIGS. 5 and 6, the lower through hole 27a in the lower bottom portion 27 is provided with a lower bearing 37 having an annular shape about the axis O. The lower bearing 37 is an example of a sliding portion. The rotary shaft 40 is vertically inserted through the lower bearing 37 and the lower portion of the rotary shaft 40 is supported by the lower bearing 37 so as to be rotatable around the axis O. The upper surface of the lower bearing 37 has the same height as the first bottom surface 27b. Lubricating oil introduced into the lower bearing 37 passes through the lower bearing 37 and falls downward.

<Speed Reducer>

Next, the speed reducer 60 will be described with reference to FIG. 4. The speed reducer 60 includes a speed reducer casing 61, an output shaft 70, and a transmission unit 80.

<Speed Reducer Casing>

The speed reducer casing 61 has a cylindrical shape extending along the axis O and open upward and downward. The upper end of the speed reducer casing 61 abuts the electric motor casing 21 from below. The upper opening of the speed reducer casing 61 is blocked by the lower casing 25 of the electric motor casing 21.

<Output Shaft>

The output shaft 70 has a rod shape extending along the axis O. The rotation of the output shaft 70 becomes the output of the rotary drive system 1. The upper portion of the output shaft 70 is disposed in the speed reducer casing 61 and the lower portion of the output shaft 70 protrudes downward from the speed reducer casing 61. An output shaft bearing 71 supporting the output shaft 70 so as to be rotatable around the axis O is provided below the inner peripheral surface of the speed reducer casing 61. The lower portion of the output shaft 70 that protrudes downward from the speed reducer casing 61 is connected to the swing pinion 223.

A lower seal 72 sealing the annular space between the inner peripheral surface of the speed reducer casing 61 and the outer peripheral surface of the output shaft 70 is provided further below the output shaft bearing 71 on the inner peripheral surface of the speed reducer casing 61. The space in the speed reducer casing 61 that is blocked from below by the lower seal 72 is the second space R2. The lower portion of the rotary shaft 40 that protrudes downward from the electric motor casing 21 is positioned above the second space R2. Lubricating oil is stored up to a predetermined height position in the second space R2. In other words, the second space R2 functions as a lubricating oil storage tank.

<Transmission Unit>

The transmission unit 80 is provided in the second space R2 in the speed reducer casing 61. The transmission unit 80 has a role of reducing the rotational speed of the rotary shaft 40 and transmitting the reduced rotational speed to the output shaft 70.

The transmission unit 80 includes multi-stage planetary gear mechanisms sequentially reducing the rotational speed from the rotary shaft 40 to the output shaft 70. In the present embodiment, the three planetary gear mechanisms of a first stage planetary gear mechanism 90, a second stage planetary gear mechanism 100, and a third stage planetary gear mechanism 110 are provided as the plurality of planetary gear mechanisms. In the present embodiment, at least one of the planetary gear mechanisms is immersed in the lubricating oil.

The first stage planetary gear mechanism 90 is a planetary gear mechanism disposed at a first stage. The first stage planetary gear mechanism 90 includes a first stage transmission shaft 91, a first stage planetary gear 92, and a first stage carrier 93. The first stage transmission shaft 91 is externally fitted from the lower end to the lower portion of the rotary shaft 40. The first stage transmission shaft 91 is rotatable around the axis O integrally with the rotary shaft 40. Outer gear teeth are formed at a part of the outer peripheral surface of the first stage transmission shaft 91.

A plurality of the first stage planetary gears 92 are provided at intervals in the circumferential direction around the first stage transmission shaft 91 so as to mesh with the outer gear teeth of the first stage transmission shaft. The first stage planetary gear 92 meshes with first stage inner gear teeth 62a formed on the inner peripheral surface of the speed reducer casing 61.

The first stage carrier 93 supports the first stage planetary gear 92 so as to be capable of rotating and revolving around the axis O of the first stage transmission shaft 91.

The second stage planetary gear mechanism 100 and the third stage planetary gear mechanism 110 are similar in configuration to the first stage planetary gear 92.

The second stage planetary gear mechanism 100 includes a second stage transmission shaft 101, a second stage planetary gear 102, and a second stage carrier 103. The second stage transmission shaft 101 is provided below the first stage transmission shaft 91 so as to be rotatable around the axis O and is connected to the first stage carrier 93. The second stage planetary gear 102 meshes with second stage inner gear teeth 62b formed on the inner peripheral surface of the speed reducer casing 61.

The third stage planetary gear mechanism 110 includes a third stage transmission shaft 111, a third stage planetary gear 112, and a third stage carrier 113. The third stage transmission shaft 111 is provided below the second stage transmission shaft 101 so as to be rotatable around the axis O and is connected to the second stage carrier 103. The third stage planetary gear 112 meshes with third stage inner gear teeth 62c formed on the inner peripheral surface of the speed reducer casing 61. The third stage carrier is connected to the output shaft 70.

The rotation of the rotary shaft 40 is transmitted to the output shaft 70 after being decelerated a plurality of times by the multi-stage planetary gear mechanisms.

<Brake Mechanism (Drive Unit)>

Next, the brake mechanism 120 as an example of a drive unit will be described with reference to FIGS. 5 and 6.

The brake mechanism 120 is disposed above the first stage planetary gear mechanism 90 in the second space R2 of the speed reducer casing 61.

The brake mechanism 120 includes a disk support portion 121, a brake disk 122, a brake plate 123, a brake piston (piston) 130, a seal portion 160, a brake spring (spring) 140, and a movement mechanism 170.

<Disk Support Portion>

The disk support portion 121 is a cylindrical member about the axis O. The lower end of the disk support portion 121 is integrally fixed over the circumferential direction to the upper portion of the first stage carrier 93 in the first stage planetary gear mechanism 90. The lower portion of the rotary shaft 40 and a part of the first stage transmission shaft 91 are positioned on the inner peripheral side of the disk support portion 121.

<Brake Disk>

The brake disk 122 is an annular member and a plurality of the brake disks 122 (two brake disks 122 in the present embodiment) are disposed at intervals in the vertical direction so as to overhang from the outer peripheral surface of the disk support portion 121. The brake disk 122 has a plate shape and the vertical direction is the plate thickness direction of the plate shape.

The brake disk 122 of the present embodiment is provided on the lower portion of the rotary shaft 40 via the disk support portion 121 and the first stage planetary gear mechanism 90. The brake disk 122 may be directly fixed so as to overhang radially outward from the lower portion of the rotary shaft 40. The brake disk 122 rotates about the axis O together with the rotary shaft 40. In the present embodiment, the brake disk 122 rotates at a rotational speed reduced by one step by the first stage planetary gear mechanism 90 with respect to the rotational speed of the rotary shaft 40.

<Brake Plate>

The brake plate 123 is an annular member and a plurality of the brake plates 123 (three brake plates 123 in the present embodiment) are disposed at intervals in the vertical direction so as to overhang from the inner peripheral surface of the speed reducer casing 61. The brake plate 123 has a plate shape and the vertical direction is the plate thickness direction of the plate shape. The brake plate 123 is provided so as to overhang from a first sliding contact inner peripheral surface 64a on the inner peripheral surface of the speed reducer casing 61. The first sliding contact inner peripheral surface 64a has an inner peripheral cylindrical surface shape about the axis O.

The plurality of brake plates 123 and the plurality of brake disks 122 are alternately disposed in the order of the brake plates 123 and the brake disks 122 downward from above. The brake plate 123 and the brake disk 122 are capable of abutting each other in the vertical direction. The outer peripheral end of the brake disk 122 faces the first sliding contact inner peripheral surface 64a at an interval and from the radially inner side. The inner peripheral end of the brake plate 123 faces the outer peripheral surface of the disk support portion 121 at an interval and from the radially outer side.

<Brake Piston>

The brake piston 130 is an annular member about the axis O and is disposed between the upper surface of the brake disk 122 and a lower surface 21a of the electric motor casing 21 in the second space R2. In the present embodiment, the brake plate 123 is interposed between the brake piston 130 and the upper surface of the brake disk 122. The brake piston 130 is disposed so as to be movable in the vertical direction, which is a direction of advancing and retreating with respect to the electric motor casing 21. In other words, the brake piston 130 is capable of reciprocating in the vertical direction.

An upper surface 130a of the brake piston 130 faces the lower surface 21a of the electric motor casing 21 from below. The lower portion of the outer peripheral surface of the brake piston 130 is a first sliding contact outer peripheral surface 131 having a circular cross-sectional shape orthogonal to the axis O. The first sliding contact outer peripheral surface 131 of the brake piston 130 is slidable in the vertical direction with respect to the first sliding contact inner peripheral surface 64a of the speed reducer casing 61. A first O-ring 131a is provided between the first sliding contact outer peripheral surface 131 and the first sliding contact inner peripheral surface 64a. In the present embodiment, the first O-ring 131a is accommodated in a groove portion formed in the first sliding contact outer peripheral surface 131. The first O-ring 131a is slidable in the vertical direction with respect to the first sliding contact inner peripheral surface 64a.

The upper portion of the outer peripheral surface of the brake piston 130 is a second sliding contact outer peripheral surface 132 having a circular cross-sectional shape orthogonal to the axis O. The second sliding contact outer peripheral surface 132 is larger in outer diameter than the first sliding contact outer peripheral surface 131. The second sliding contact outer peripheral surface 132 of the brake piston 130 is slidable in the vertical direction with respect to a second sliding contact inner peripheral surface 64b of the speed reducer casing 61. The second sliding contact inner peripheral surface 64b of the speed reducer casing 61 is larger in inner diameter than the first sliding contact inner peripheral surface 64a. A second O-ring 132a is provided between the second sliding contact outer peripheral surface 132 and the second sliding contact inner peripheral surface 64b. In the present embodiment, the second O-ring 132a is accommodated in a groove portion formed in the second sliding contact outer peripheral surface 132. The second O-ring 132a is slidable in the vertical direction with respect to the second sliding contact inner peripheral surface 64b.

The step portion in the brake piston 130 that is between the first sliding contact outer peripheral surface 131 and the second sliding contact outer peripheral surface 132 is a pressure receiving surface 133 forming a flat shape orthogonal to the axis O, facing downward, and forming an annular shape.

The step portion in the speed reducer casing 61 that is between the first sliding contact inner peripheral surface 64a and the second sliding contact inner peripheral surface 64b is a stepped surface 64c forming a flat shape orthogonal to the axis O, facing upward, and forming an annular shape.

The pressure receiving surface 133 and the stepped surface 64c face each other in the vertical direction and approach and separate from each other as the brake piston 130 moves in the vertical direction. The annular space between the pressure receiving surface 133 and the stepped surface 64c is a hydraulic pressure supply space R4. In the hydraulic pressure supply space R4, liquid tightness is ensured by the first O-ring 131a and the second O-ring 132a. The volume of the hydraulic pressure supply space R4 changes as the brake piston 130 moves in the vertical direction.

The speed reducer casing 61 has a hydraulic pressure supply hole 61a interconnecting the stepped surface 64c and the outside of the speed reducer casing 61. The hydraulic pressure supply space R4 communicates with the outside via the hydraulic pressure supply hole 61a.

On an annular lower surface 130b of the brake piston 130, a plate abutting surface 134 having an annular shape about axis O is formed so as to protrude from the lower surface 130b. The plate abutting surface 134 faces the brake plate 123 from above over the entire circumferential direction.

As shown in FIG. 5, in the brake piston 130, the position where the plate abutting surface 134 abuts the brake plate 123 and the upper surface 130a is spaced downward from the lower surface 21a of the electric motor casing 21 is the bottom dead center of the reciprocating movement.

As shown in FIG. 6, in the brake piston 130, the position where the plate abutting surface 134 is spaced upward from the brake plate 123 and the upper surface 130a abuts the lower surface 21a of the electric motor casing 21 is the top dead center of the reciprocating movement.

<Storage Portion>

The upper surface 130a of the brake piston 130 has a piston-side accommodation recessed portion 135 recessed downward from above. A plurality of the piston-side accommodation recessed portions 135 are disposed at intervals in the circumferential direction. The piston-side accommodation recessed portion 135 has a circular shape in a cross-sectional view orthogonal to the axis O.

The lower surface 21a of the electric motor casing 21 has a casing-side accommodation recessed portion 28 recessed upward from below. A plurality of the casing-side accommodation recessed portions 28 are disposed at intervals in the circumferential direction. The casing-side accommodation recessed portion 28 has a circular shape having the same inner diameter as the piston-side accommodation recessed portion 135 in a cross-sectional view orthogonal to the axis O. The casing-side accommodation recessed portion 28 is provided so as to correspond to the piston-side accommodation recessed portion 135. In other words, each casing-side accommodation recessed portion 28 and each piston-side accommodation recessed portion 135 are provided at the same circumferential position so as to correspond to each other in a one-to-one relationship. The central axes of the corresponding casing-side accommodation recessed portion 28 and piston-side accommodation recessed portion 135 are coaxial.

A space defined by the casing-side accommodation recessed portion 28 and the piston-side accommodation recessed portion 135 is defined as a spring accommodation space R3. The spring accommodation space R3 functions as a storage portion 180 in which lubricating oil is stored. The spring accommodation space R3 communicates with the first space R1 via a hole portion 29 formed in the lower bottom portion 27 of the electric motor casing 21. The hole portion 29 penetrates the lower bottom portion 27 in the vertical direction. The opening on the upper side of the hole portion 29 is open to the second bottom surface 27c of the lower bottom portion 27. As a result, the hole portion 29 is open toward the upper portion of the first space R1.

<Seal Portion>

An annular projecting portion 130c protruding annularly upward about the central axis O of the piston-side accommodation recessed portion 135 is formed around the piston-side accommodation recessed portion 135 in the upper surface 130a of the brake piston 130. An annular recessed portion 27e recessed annularly upward about the central axis O of the casing-side accommodation recessed portion 28 is formed around the casing-side accommodation recessed portion 28 in the lower surface 21a of the electric motor casing 21.

The outer peripheral surface of the annular projecting portion 130c and the inner peripheral surface of the annular recessed portion 27e have corresponding diameters. The outer peripheral surface of the annular projecting portion 130c is slidable in the vertical direction with respect to the inner peripheral surface of the annular recessed portion 27e. The upper end of the annular projecting portion 130c abuts the upper end of the annular recessed portion 27e when the brake piston 130 is positioned at the top dead center.

The seal portion 160 as an O-ring surrounding the spring accommodation space R3 from the periphery is provided between the outer peripheral surface of the annular projecting portion 130c and the inner peripheral surface of the annular recessed portion 27e. In the present embodiment, the seal portion 160 is accommodated in the groove portion that is formed in the outer peripheral surface of the annular projecting portion 130c. The seal portion 160 abuts the inner peripheral surface of the annular recessed portion 27e regardless of whether the brake piston 130 is at the top dead center or the bottom dead center. As a result, the seal portion 160 liquid-tightly separates the spring accommodation space R3 from the inside of the second space R2.

<Brake Spring>

The brake spring 140 is provided in the spring accommodation space R3 and presses the brake piston 130 in a direction away from the electric motor casing 21.

The brake spring 140 of the present embodiment is a coil spring and is disposed in a posture allowing expansion and contraction in the vertical direction in the spring accommodation space R3. The brake spring 140 is accommodated in a compressed state in the spring accommodation space R3. The upper end of the brake spring 140 abuts the bottom surface of the casing-side accommodation recessed portion 28 in the electric motor casing 21 and the lower end of the brake spring 140 abuts the bottom surface of the piston-side accommodation recessed portion 135 in the brake piston 130.

In a state where no external force from the outside acts on the brake piston 130, the brake piston 130 is at the bottom dead center position separated from the electric motor casing 21 by the pressing force of the brake spring 140 as shown in FIG. 5. The volume of the spring accommodation space R3 is maximized at this time.

<Movement Mechanism>

The movement mechanism 170 moves the brake piston 130 upward so as to approach the electric motor casing 21 against the pressure of the brake spring 140. The movement mechanism 170 includes a branch oil path 171, an on-off valve 172, and a controller 173.

The branch oil path 171 is a flow path branching from a hydraulic circuit through which the hydraulic pressure generated by the hydraulic pump 238 discharging hydraulic oil flows. The branch oil path 171 is connected from the outside to the hydraulic pressure supply hole 61a.

The branch oil path 171 is provided with the on-off valve 172, which is a valve opening and closing the branch oil path 171. The on-off valve 172 that is in a closed state prohibits hydraulic oil supply from the hydraulic circuit to the hydraulic pressure supply hole 61a. The on-off valve 172 that is in an open state allows hydraulic oil supply from the hydraulic circuit to the hydraulic pressure supply hole 61a.

The controller 173 controls the opening and closing of the on-off valve 172.

The controller 173 controls the on-off valve 172 such that the on-off valve 172 is opened by using, as an input, a lock release signal P that is output in response to a release operation of the swinging lock lever (lock lever) provided in the cab 231. The on-off valve 172 is closed in a case where the swinging lock lever is in a lock state. The on-off valve 172 is opened only in a case where the swinging lock lever is in an unlock state. Accordingly, the hydraulic oil discharged by the hydraulic pump 238 is supplied to the hydraulic pressure supply hole 61a only in a case where a release operation of the swinging lock lever is performed and the swinging lock lever is in the unlock state.

The hydraulic oil introduced into the hydraulic pressure supply hole 61a reaches the hydraulic pressure supply space R4. Hydraulic pressure is generated by the hydraulic oil and an upward force resulting from the hydraulic pressure acts on the pressure receiving surface 133 of the brake piston 130 that defines the hydraulic pressure supply space R4. As a result, the brake piston 130 moves upward against the pressure of the brake spring 140. The brake piston 130 moves to the top dead center by the hydraulic oil being supplied to the hydraulic pressure supply space R4 as described above. The volume of the spring accommodation space R3 is minimized at this time.

<Lubricating Oil Circulation Unit>

As shown in FIG. 3, the lubricating oil circulation unit 150 supplies lubricating oil into the first space R1 in the electric motor casing 21 and re-supplies the lubricating oil collected from the inside of the second space R2 in the speed reducer casing 61 into the first space R1.

The lubricating oil circulation unit 150 includes a lubricating oil flow path 151, a lubricating oil pump 152, a cooling unit 153, and a strainer 154.

The lubricating oil flow path 151 is a flow path formed by a flow path forming member such as piping provided outside the rotary drive device 10. A first end of the lubricating oil flow path 151, which is an upstream side end portion thereof, is connected to the second space R2 in the speed reducer casing 61. In the present embodiment, the first end of the lubricating oil flow path 151 is connected to the part in the second space R2 that is between the output shaft bearing 71 and the lower seal 72.

A second end of the lubricating oil flow path 151, which is a downstream side end portion thereof, is connected to the opening of the intra-rotor flow path F at the upper end of the rotary shaft 40. The second end of the lubricating oil flow path 151 is connected to the first space R1 in the electric motor casing 21 via the intra-rotor flow path F.

The lubricating oil pump 152 is provided in the flow path of the lubricating oil flow path 151 and pumps lubricating oil from the first end toward the second end of the lubricating oil flow path 151, that is, from the second space R2 side toward the first space R1 side.

The cooling unit 153 is provided at the part of the lubricating oil flow path 151 that is downstream of the lubricating oil pump 152. The cooling unit 153 cools the lubricating oil that flows through the lubricating oil flow path 151 by heat exchange with the external atmosphere.

The strainer 154 is provided at the part of the lubricating oil flow path 151 that is upstream of the lubricating oil pump 152. The strainer 154 has a filter removing dust and dirt from the lubricating oil that passes through the lubricating oil flow path 151. It is preferable that the strainer 154 includes a magnetic filter removing, for example, iron powder generated from the gear teeth of the speed reducer 60.

<Action and Effect>

When the engine 236 of the hydraulic shovel 200 is started, hydraulic pressure is generated by the hydraulic pump 238 being simultaneously driven. Then, by the swinging lock lever being released, the brake of the rotary shaft 40 of the rotary drive system is released and the rotary shaft becomes rotatable.

The brake piston 130 of the brake mechanism 120 is pressed downward by the brake spring 140. As shown in FIG. 5, in a case where the swinging lock lever is in the lock state, the on-off valve 172 in the movement mechanism 170 of the brake mechanism 120 is closed and no hydraulic oil is supplied to the hydraulic pressure supply space R4. Accordingly, the brake piston 130 presses the brake disk 122 via the brake plate 123 in a state of being positioned at the bottom dead center. At this time, the rotary shaft 40 is in a non-rotatable brake state by the frictional force between the brake plate 123 and the brake disk 122.

Then, the lock release signal P is input to the controller 173 of the movement mechanism 170 when a release operation for shifting the swinging lock lever from the lock state to the unlock state is performed. As a result, the controller 173 controls the on-off valve 172 from the closed state to the open state. By the on-off valve 172 being opened, hydraulic oil is supplied and hydraulic pressure is generated in the hydraulic pressure supply space R4. Then, the brake piston 130 that has received the hydraulic pressure on the pressure receiving surface 133 moves upward and is positioned at the top dead center. Accordingly, the pressing of the brake plate 123 and the brake disk 122 by the brake piston 130 is released and the rotary shaft 40 is put into a rotatable brake release state.

Then, the rotary drive system 1 is driven and the upper swing body 230 swings by the swinging lever in the cab 231 being operated.

In other words, when the swinging lever is operated, alternating current electric power is supplied to each coil 32 of the stator 30 of the electric motor 20 via the inverter 239 and the rotor 38 rotates with respect to the stator 30 by each permanent magnet following the rotating magnetic field that is generated by the coils 32. The rotation of the rotary shaft 40 of the rotor 38 is decelerated via the transmission unit 80 in the speed reducer 60 and transmitted to the output shaft 70. In the present embodiment, the deceleration is sequentially performed via the three-stage planetary gear mechanisms. The swinging operation of the upper swing body 230 is performed by the rotation of the output shaft 70.

The electric motor 20 is driven with high torque when the upper swing body 230 swings. Accordingly, the temperatures of the rotor core 42 and the permanent magnet rise due to the iron loss in the rotor core 42 and the eddy current loss in the permanent magnet. At the same time, the temperature of the stator 30 rises due to the copper loss in the coil 32 and the iron loss in the stator core 31. When the temperature of the stator 30 is high, the temperature of the rotor core 42 becomes higher due to the radiant heat of the stator 30. Accordingly, cooling oil is supplied into the electric motor 20 by the lubricating oil circulation unit 150.

When the swinging lever is operated, the lubricating oil pump 152 of the lubricating oil circulation unit 150 is driven together with the drive of the electric motor 20. As a result, the lubricating oil stored by the second space R2 being used as a tank is partially introduced into the intra-rotor flow path F of the electric motor 20 via the lubricating oil flow path 151. The lubricating oil cools the rotor core 42 and the permanent magnets in the course of flowing through the intra-rotor flow path F. Then, the lubricating oil discharged from the rotor 38 to the first space R1 in the electric motor casing 21 is sprayed radially outward by the centrifugal force resulting from the rotation of the rotor 38 and cools the coil 32 and the stator core 31.

Subsequently, the lubricating oil that has fallen in the first space R1 passes through the communication hole 50 penetrating the lower bottom portion 27 of the electric motor casing 21 or passes through the lower bearing 37. Then, the lubricating oil is introduced into the second space R2 in the speed reducer casing 61. The lubricating oil passes through the lower bearing 37 and thus lubricity is ensured in the lower bearing 37.

The lubricating oil introduced into the second space R2 merges with the lubricating oil stored by the second space R2 being used as a tank. In the second space R2, each planetary gear mechanism is lubricated by the lubricating oil falling from the electric motor casing 21 or by the stored lubricating oil.

In addition, the cooling mechanism of the electric motor 20 is not limited to the configuration described above and various configurations can be adopted.

Here, as described above, the lubricating oil pump 152 is started at the same time when the electric motor 20 is started. The lubricating oil that is supplied as a result ensures lubricity in the lower bearing 37. However, in a case where the external atmosphere has a low temperature or the like, it takes time for the lubricating oil that has passed through the intra-rotor flow path F to reach the lower bearing 37 due to an increase in the viscosity of the lubricating oil. As a result of the situation in which it is difficult to supply lubricating oil to the lower bearing 37, the rotary shaft 40 may rotate in a state where the lower bearing 37 is not lubricated.

Here, the spring accommodation space R3 of the present embodiment is open toward the upper portion of the first space R1. Accordingly, when the rotary drive system 1 is operated and the lubricating oil pump 152 is driven, lubricating oil is introduced into the spring accommodation space R3 via the hole portion 29. In other words, the lubricating oil that flows down from the stator 30 and the rotor 38 is partially stored in the spring accommodation space R3. The spring accommodation space R3 is filled with the lubricating oil even after the operation of the hydraulic shovel 200 is ended.

Then, when the operation of the hydraulic shovel 200 is started again and the release operation of the swinging lock lever is performed, hydraulic pressure is applied to the brake piston 130 and the brake piston 130 moves from the bottom dead center to the top dead center. As a result of this movement, the volume of the spring accommodation space R3 defined by the brake piston 130 and the electric motor casing 21 decreases. As a result, the lubricating oil stored in the spring accommodation space R3 is partially discharged into the first space R1 via the hole portion 29. By the lubricating oil discharged into the first space R1 as described above being introduced into the lower bearing 37, it is possible to lubricate the lower bearing 37 while the electric motor 20 and the lubricating oil pump 152 are driven. Accordingly, in a case where the electric motor 20 and the lubricating oil pump 152 are driven at the same time, it is possible to lubricate the lower bearing 37 in advance even in a case where lubricating oil supply to the lower bearing 37 is delayed.

As described above, according to the present embodiment, it is possible to discharge the lubricating oil stored in the spring accommodation space R3 into the first space R1 by input from the outside. The lubricating oil discharged in this manner is introduced into the lower bearing 37 and it is possible to lubricate the lower bearing 37 as a result.

Accordingly, it is possible to smoothly supply the lubricating oil discharged from the spring accommodation space R3 to the lower bearing 37 as a sliding portion even in a situation in which it is difficult to supply lubricating oil from the outside.

The spring accommodation space R3 is defined by the electric motor casing 21 and the brake piston 130 and used as the storage portion 180 in which lubricating oil is stored. Accordingly, it is possible to make compact the configuration of the mechanism itself that is capable of supplying lubricating oil to the first space R1.

In the present embodiment, the drive unit that is capable of discharging lubricating oil into the first space R1 is configured by means of the brake mechanism 120 capable of braking the rotation of the rotary shaft 40 and releasing the braking. In other words, it is possible to realize a configuration in which both the brake mechanism 120 and a lubricating oil discharge mechanism are used together, and thus there is no need to provide separate mechanisms and it is possible to avoid an increase in device complexity.

The spring accommodation space R3 is defined by the casing-side accommodation recessed portion 28 recessed from the lower surface 21a of the electric motor casing 21 and the piston-side accommodation recessed portion 135 recessed from the upper surface 130a of the brake piston 130, and thus there is no need to separately provide a member for forming the spring accommodation space R3. In addition, the spring accommodation space R3 is configured to be accommodated in the electric motor casing 21 and the brake piston 130, and thus it is possible to make compact the entire device.

The spring accommodation space R3 is isolated from the outside by the seal portion 160, and thus it is possible to store reliably lubricating oil in the spring accommodation space R3.

In particular, in the present embodiment, the electric motor 20 and the speed reducer 60 has a unified lubrication system and the electric motor 20 is provided with no tank. Accordingly, the lower bearing 37 is not immersed in lubricating oil and the lubricity of the lower bearing 37 depends on the lubricating oil that is supplied from the outside and flows. In the present embodiment, it is possible to ensure the lubricity of the lower bearing 37 by the lubricating oil discharged from the spring accommodation space R3 even in a case where it is difficult for the lubricating oil that is supplied from the outside to reach the lower bearing 37 under the situation described above.

In the present embodiment, the hydraulic pump 238 is driven by the rotation of the engine 236 and hydraulic pressure is generated as a result. Then, the brake of the rotary shaft 40 is released by the swinging lock lever being released and it is possible to discharge lubricating oil from the spring accommodation space R3 to the first space R1 at the same time. Accordingly, it is possible to reliably guide lubricating oil to the lower bearing 37 before the rotary shaft 40 rotates.

In addition, lubricating oil may be discharged from the spring accommodation space R3 by a lock operation and unlock operation of the swinging lock lever during, for example, not only the operation of the hydraulic shovel 200 but also the start of the operation of the hydraulic shovel 200. In this manner, lubricating oil is discharged vigorously, and thus it is possible to cool, for example, the lower coil end 32b of the stator positioned above the hole portion 29.

### Second Embodiment

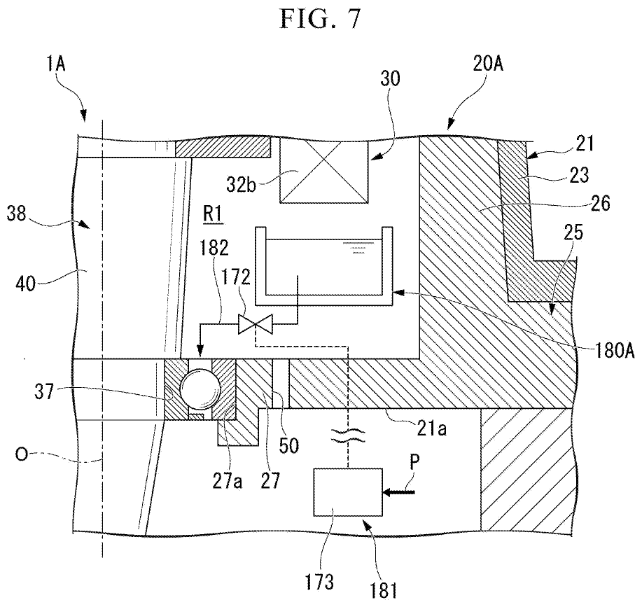

Next, a rotary drive system 1A according to a second embodiment of the present invention will be described with reference to FIG. 7. In the second embodiment, the same components as those in the first embodiment are denoted by the same reference numerals and detailed description thereof is omitted.

A storage portion 180A of the rotary drive system IA of the second embodiment is provided in the first space R1. In other words, the storage portion 180A is provided below the lower coil end 32b in the first space R1. The storage portion 180A has a box shape with an upper opening and lubricating oil is introduced from above via the opening portion.

The rotary drive system 1A of the second embodiment includes a drive unit 181 discharging the lubricating oil in the storage portion 180A into the first space R1 in response to input from the outside. The drive unit 181 has piping 182 having one end open to the storage portion 180A and the other end open to the first space R1. The other end of the piping 182 is preferably open downward above, for example, the lower bearing 37 serving as a sliding portion.

The drive unit 181 includes the on-off valve 172 disposed in the pipeline of the piping 182. The on-off valve 172 is configured to be opened and closed by the controller 173 similar to the controller 173 of the first embodiment.

When the rotary drive system 1A is operated, lubricating oil falling from above is introduced into the storage portion 180A via the opening. As a result, the lubricating oil is stored in the storage portion 180A.

Then, the controller 173 opens the on-off valve 172 that is closed based on input from the outside as in the first embodiment. As a result, the lubricating oil in the storage portion 180A is discharged into the first space R1 via the piping. It is possible to lubricate the lower bearing 37 by the lubricating oil discharged in this manner.

### Another Embodiment

Although the embodiments of the present invention have been described above, the present invention is not limited thereto and can be appropriately changed without departing from the technical idea of the present invention.

Although the lock release signal P output as the swinging lock lever is released is input to the controller 173 of the movement mechanism 170 in the embodiments, the present invention is not limited thereto. For example, a configuration in which lubricating oil in the storage portion 180 and 180A is discharged into the first space R1 by a signal output by a switch provided in the cab 231 may be adopted. In addition, a configuration in which lubricating oil is discharged into the first space R1 in conjunction with the operation of an existing switch provided in the hydraulic shovel 200 may be adopted.

The configuration of the movement mechanism 170 is not limited to the first and second embodiments and another configuration may be adopted insofar as lubricating oil can be discharged into the first space R1 in response to input from the outside. For example, a configuration in which lubricating oil can be discharged by an actuator being driven in response to a signal from the outside may be adopted.

Described in the first embodiment is an example in which the spring accommodation space R3 as the storage portion 180 is defined by the casing-side accommodation recessed portion 28 of the electric motor casing 21 and the piston-side accommodation recessed portion 135 of the brake piston 130. However, the present invention is not limited thereto and the spring accommodation space R3 may be formed by a recessed portion formed in one of the electric motor casing 21 and the brake piston 130.

The seal portion 160 sealing the spring accommodation space R3 as the storage portion 180 is not limited to the configuration of the embodiment and another configuration may be adopted. Examples thereof include a seal portion such as an O-ring provided between the upper surface 130a of the brake piston 130 and the lower surface 21a of the electric motor casing 21.

The lubricating oil storage portion 180 may be formed separately from the spring accommodation space R3.

The drive unit discharging lubricating oil may be configured by means of a simple piston that has no brake function instead of the brake piston 130.

Although an example in which the lower bearing 37 is a sliding portion has been described in the embodiment, discharged lubricating oil may be guided to another sliding portion in another configuration.

In the embodiment, the on-off valve 172 is controlled from the closed state to the open state via the controller 173 when the swinging lock lever is released. However, the present invention is not limited thereto. For example, in another configuration, hydraulic oil may be supplied to the branch oil path 171 by the on-off valve 172 being directly opened from the closed state by the swinging lock lever being operated. In addition, the on-off valve 172 may be opened from the closed state in a case where various operation lever operations including the operation on the upper swing body 230 are performed.

Although an example in which the present invention is applied to the rotary drive system 1 and 1A of the hydraulic shovel 200 as a work machine has been described in the embodiments, the present invention may be applied to the rotary drive system 1 and 1A as a mechanism swinging or rotating a part of another work machine.

The present invention may be applied to an electric motor alone as well as the rotary drive system 1 and 1A including the electric motor 20 and the speed reducer 60 and a configuration in which the electric motor 20 and a hydraulic motor driven by hydraulic pressure are combined may be applied.

### INDUSTRIAL APPLICABILITY

According to the electric motor, the rotary drive system, and the hydraulic shovel of the above aspect, it is possible to smoothly supply lubricating oil to a sliding portion.

### REFERENCE SIGNS LIST

1: Rotary drive system

1A: Rotary drive system

10: Rotary drive device

20: Electric motor

20A: Electric motor

21: Electric motor casing

21a: Lower surface

22: Upper casing

23: Upper cylindrical portion

24: Upper bottom portion

24a: Upper through hole

25: Lower casing

26: Lower cylindrical portion

27: Lower bottom portion (partition wall)

27a: Lower through hole

27b: First bottom surface

27c: Second bottom surface

27d: Stepped portion

27e: Annular recessed portion

28: Casing-side accommodation recessed portion (recessed portion)

29: Hole portion

30: Stator

31: Stator core

32: Coil

32a: Upper coil end

32b: Lower coil end

35: Upper seal

36: Upper bearing

37: Lower bearing (sliding portion)

38: Rotor

40: Rotary shaft

42: Rotor core

45: Lower end plate

46: Upper end plate

50: Communication hole

60: Speed reducer

61: Speed reducer casing

61a: Hydraulic pressure supply hole

62a: First stage inner gear teeth

62b: Second stage inner gear teeth

62c: Third stage inner gear teeth

64a: First sliding contact inner peripheral surface

64b: Second sliding contact inner peripheral surface

64c: Stepped surface

70: Output shaft

71: Output shaft bearing

72: Lower seal

80: Transmission unit

90: First stage planetary gear mechanism

91: First stage transmission shaft

92: First stage planetary gear

93: First stage carrier

100: Second stage planetary gear mechanism

101: Second stage transmission shaft

102: Second stage planetary gear

103: Second stage carrier

110: Third stage planetary gear mechanism

111: Third stage transmission shaft

112: Third stage planetary gear

113: Third stage carrier

120: Brake mechanism (drive unit)

121: Disk support portion

122: Brake disk

123: Brake plate

130: Brake piston

130a: Upper surface

130b: Lower surface

130c: Annular projecting portion

131: First sliding contact outer peripheral surface

131a: First O-ring

132: Second sliding contact outer peripheral surface

132a: Second O-ring

133: Pressure receiving surface

134: Plate abutting surface

135: Piston-side accommodation recessed portion (recessed portion)

140: Brake spring

150: Lubricating oil circulation unit

151: Lubricating oil flow path

152: Lubricating oil pump

153: Cooling unit

154: Strainer

160: Seal portion

170: Movement mechanism

171: Branch oil path

172: On-off valve

173: Controller

180: Storage portion

180A: Storage portion

181: Drive unit

182: Piping

200: Hydraulic shovel

211: Crawler

210: Undercarriage

220: Swing circle

221: Outer race

222: Inner race

223: Swing pinion

230: Upper swing body

231: Cab

232: Work equipment

233: Boom

234: Arm

235: Bucket

236: Engine

237: Generator motor

238: Hydraulic pump

239: Inverter

240: Capacitor

L: Swing axis

O: Axis

S: Liquid surface

R1: First space

R2: Second space

R3: Spring accommodation space

R4: Hydraulic pressure supply space

F: Intra-rotor flow path

P: Lock release signal

1. An electric motor comprising:
a rotor including a rotary shaft that has an axis extending vertically and rotates around the axis and a rotor core fixed to an outer peripheral surface of the rotary shaft;
a stator surrounding the rotor core from an outer peripheral side of the stator;
a partition wall partitioning a first space where the rotor and the stator are disposed and lubricating oil is supplied from an outside;
a storage portion configured to store the lubricating oil supplied into the first space;
a drive unit discharging the lubricating oil inside the storage portion into the first space; and
sliding portions into each of which the lubricating oil discharged from the inside of the storage portion is introduced, wherein
the drive unit includes:
a piston provided outside the first space and configured to advance and retreat with respect to the partition wall and defining the storage portion together with the partition wall,
a spring provided inside the storage portion and pressing the piston in a direction away from the partition wall, and
a movement mechanism moving the piston so as to approach the partition wall against a pressure of the spring, and
wherein the storage portion is open to the first space via a hole portion formed in the partition wall.

2. (canceled)

3. The electric motor according to claim 2-1, further comprising a brake disk provided on a lower portion of the rotary shaft protruding downward from the partition wall and overhanging radially outwards from the rotary shaft,
wherein the hole portion vertically penetrates the partition wall,
the piston is provided between a lower surface of the partition wall and an upper surface of the brake disk and configured to advance and retreat in a vertical direction, and
the storage portion is defined by a recessed portion recessed from at least one of the lower surface of the partition wall and an upper surface of the piston.

4. The electric motor according to claim 1, further comprising a seal portion provided between the partition wall and the piston and blocking a periphery of the storage portion.

5. A rotary drive system comprising:
the electric motor according to claim 3;
a speed reducer including an output shaft provided in a second space partitioned downward by the partition wall and configured to rotate around the axis, and a transmission unit provided in the second space, decelerating the rotation of the rotary shaft, and transmitting a decelerated rotation to the output shaft; and
a lubricating oil circulation unit including a lubricating oil flow path connecting the first space and the second space, and a lubricating oil pump provided in the lubricating oil flow path and pumping lubricating oil from the second space side to the first space side,
wherein a communication hole allowing the first space and the second space to communicate with each other is formed in the partition wall, and
the sliding portion is a lower bearing supporting the lower portion of the rotary shaft so as to be rotatable around the axis.

6. A hydraulic shovel comprising:
the rotary drive system according to claim 5;
an undercarriage;
an upper swing body provided on the undercarriage and swinging by rotating the rotary drive system; and
a hydraulic pump generating hydraulic pressure,
wherein the piston has a pressure receiving surface facing downward, and
the movement mechanism supplies the hydraulic pressure generated by the hydraulic pump to the pressure receiving surface by using a signal sent in response to a release operation of a lock lever as an input.

7. The electric motor according to claim 3, further comprising
a seal portion provided between the partition wall and the piston and blocking a periphery of the storage portion.

8. A rotary drive system comprising:
the electric motor according to claim 4;
a speed reducer including an output shaft provided in a second space partitioned downward by the partition wall and configured to rotate around the axis, and a transmission unit provided in the second space, decelerating the rotation of the rotary shaft, and transmitting a decelerated rotation to the output shaft; and
a lubricating oil circulation unit including a lubricating oil flow path connecting the first space and the second space, and a lubricating oil pump provided in the lubricating oil flow path and pumping lubricating oil from the second space side to the first space side,
wherein a communication hole allowing the first space and the second space to communicate with each other is formed in the partition wall, and
the sliding portion is a lower bearing supporting the lower portion of the rotary shaft so as to be rotatable around the axis.

9. A rotary drive system comprising:
the electric motor according to claim 7;
a speed reducer including an output shaft provided in a second space partitioned downward by the partition wall and configured to rotate around the axis, and a transmission unit provided in the second space, decelerating the rotation of the rotary shaft, and transmitting a decelerated rotation to the output shaft; and
a lubricating oil circulation unit including a lubricating oil flow path connecting the first space and the second space, and a lubricating oil pump provided in the lubricating oil flow path and pumping lubricating oil from the second space side to the first space side,
wherein a communication hole allowing the first space and the second space to communicate with each other is formed in the partition wall, and
the sliding portion is a lower bearing supporting the lower portion of the rotary shaft so as to be rotatable around the axis.

10. A hydraulic shovel comprising:
the rotary drive system according to claim 8;
an undercarriage;
an upper swing body provided on the undercarriage and swinging by rotating the rotary drive system; and
a hydraulic pump generating hydraulic pressure,
wherein the piston has a pressure receiving surface facing downward, and
the movement mechanism supplies the hydraulic pressure generated by the hydraulic pump to the pressure receiving surface by using a signal sent in response to a release operation of a lock lever as an input.

11. A hydraulic shovel comprising:
the rotary drive system according to claim 9;
an undercarriage;
an upper swing body provided on the undercarriage and swinging by rotating the rotary drive system; and
a hydraulic pump generating hydraulic pressure,
wherein the piston has a pressure receiving surface facing downward, and
the movement mechanism supplies the hydraulic pressure generated by the hydraulic pump to the pressure receiving surface by using a signal sent in response to a release operation of a lock lever as an input.
